(19) United States
(12) Patent Application Publication
(10) Pub. No.: US 2026/0120185 A1
(43) Pub. Date: Apr. 30, 2026

(54) System and Method for Simulating Financial Markets with Blockchain-Based Assets

(71) Applicant: Orrin Vincent Campbell, Wappingers Falls, NY (US)

(72) Inventor: Orrin Vincent Campbell, Wappingers Falls, NY (US)

(21) Appl. No.: 18/930,892

(22) Filed: Oct. 29, 2024

(51) Int. Cl. G06Q 40/04; G06Q 40/06; G06Q 50/20

(52) U.S. Cl. CPC G06Q 40/04; G06Q 40/06; G06Q 50/20

(57) ABSTRACT

A computer-implemented system simulates financial markets using blockchain-based assets to support trading, portfolio management, and market-dynamic gameplay. The system is implemented digitally and may optionally support physical or hybrid gameplay formats that integrate physical game components with digital portfolio interfaces. Players interact with blockchain-based assets, including cryptocurrencies, digital tokens, and non-fungible tokens, whose values dynamically adjust in response to simulated economic factors. Program modules apply rule-based logic to stored asset representations to update asset values and portfolio state during gameplay, synchronizing interactions across digital and physical formats. The system further supports reward mechanisms that grant digital assets or redeemable points and provides adaptive visualizations that reflect changing market conditions, enabling an interactive simulation of financial asset behavior.

### CROSS-REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### INCORPORATION-BY-REFERENCE OF MATERIAL SUBMITTED VIA THE PATENT ELECTRONIC SYSTEM

Not Applicable.

### SEQUENCE LISTING

Not Applicable.

### FIELD OF THE INVENTION

The present invention relates to game systems and methods for simulating investment and portfolio management. More particularly, the invention concerns the representation and simulated management of blockchain-based assets within an interactive game environment.

### BACKGROUND OF THE INVENTION

The emergence of blockchain technology, digital tokens, and cryptocurrency markets has increased the demand for simulation systems that model the behavior of diverse digital assets. Existing financial games typically limit players to traditional instruments or simplified digital currencies without capturing the wide range of blockchain-based assets now available.

Many prior systems further lack mechanisms for representing dynamic market conditions, player decisions that affect asset values, and key events that influence simulated asset behavior. Accordingly, there is a need for a game system capable of simulating investment decisions involving blockchain-based assets in a dynamic environment that reflects variable market conditions and player activity.

### BRIEF SUMMARY OF THE INVENTION

The invention provides a game system enabling players to simulate investment and portfolio management using blockchain-based assets. The system represents asset classes including, but not limited to, cryptocurrencies, digital tokens, altcoins, non-fungible tokens (NFTs), memecoins, and other blockchain-based financial instruments.

The system further includes dynamic elements that affect simulated asset values based on conditions such as market trends, player actions, seasonal factors, or external events. Players manage a simulated portfolio that displays current and historical values of their assets.

The system may provide a reward mechanism granting points, credits, or blockchain-based rewards tied to player activity or achievements. The game may be implemented digitally, physically, or in hybrid formats.

Optional features may include artificial intelligence (AI) for strategic suggestions or adaptive gameplay, and augmented reality (AR) or virtual reality (VR) elements for immersive visualization of simulated market conditions.

### BRIEF DESCRIPTION OF THE DRAWINGS

FIG. 1 illustrates an example overview of system operation including asset definition, dynamic condition modeling, portfolio management interactions, reward mechanisms, platform adaptability, game modes, and optional AI and AR/VR features.

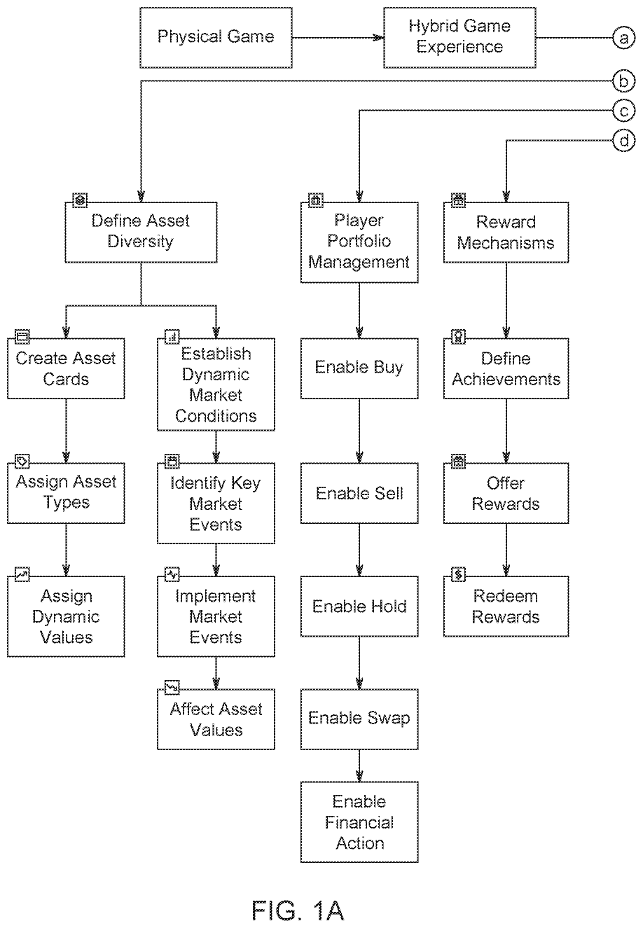

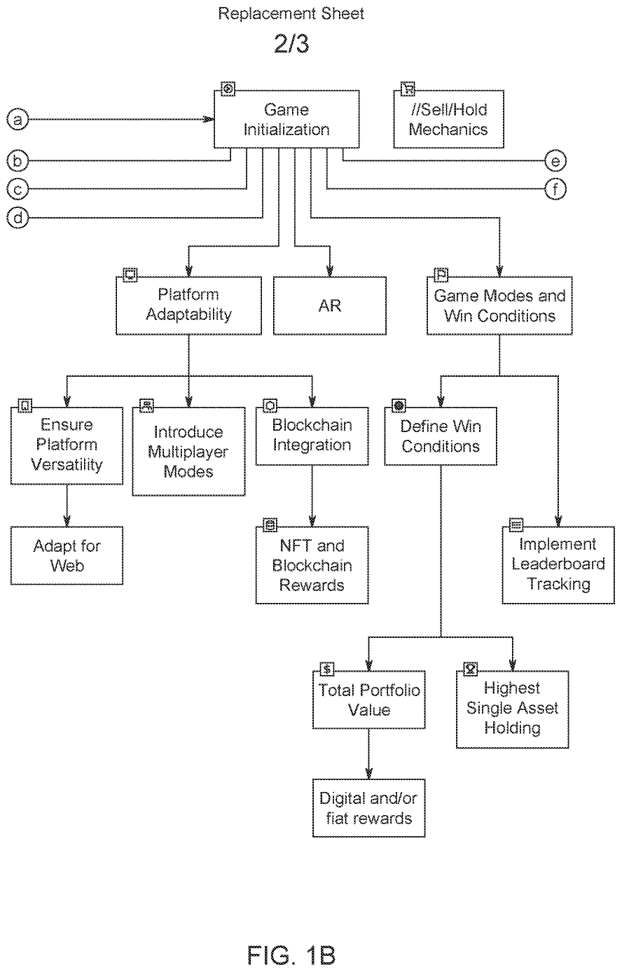

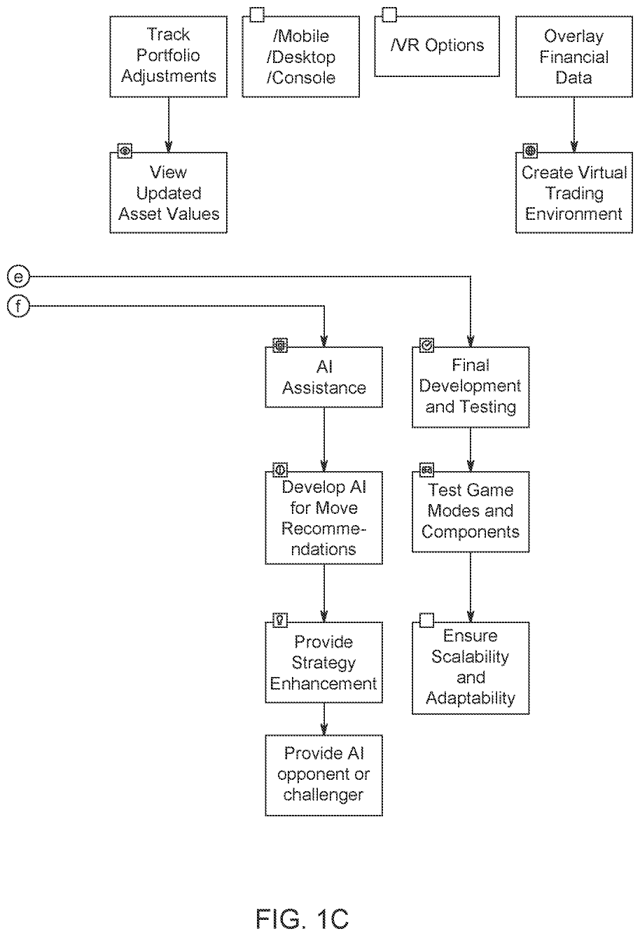

### DETAILED DESCRIPTION OF THE INVENTION

### Overview

The invention provides a game system enabling players to simulate investment strategies using blockchain-based assets. The system may be implemented through digital platforms, physical components, or a combination of both.

### Asset Classes

The system can represent a variety of blockchain-based assets including cryptocurrencies, altcoins, digital tokens, NFTs, memecoins, and other blockchain-based financial instruments. Additional asset types, such as traditional financial instruments, may also be represented in some implementations.

The system assigns dynamic values to represented assets for use during gameplay.

### Dynamic Elements

Asset values are influenced by dynamic elements that reflect changing conditions. The dynamic elements may include:
Market trends;
Player decisions during gameplay;
Seasonal factors; and
External events or conditions that affect simulated markets.

These dynamic elements collectively contribute to adjustments in simulated asset values throughout gameplay.

### Player Portfolio Representation

The system includes a portfolio management interface displaying each player's assets and their current simulated values. The interface may also present historical information to support strategic planning.

Players can execute simulated actions including buying, selling, holding, or swapping assets as permitted by game rules.

### Interchangeability of Assets

In various implementations, players may interchange assets by converting or exchanging one type of digital or blockchain-based asset for another within the game environment.

### Reward System

The game may provide rewards such as points, credits, XP points, or blockchain-based assets. Rewards may be granted in response to specific achievements, portfolio performance, or completion of challenges.

### Winning Conditions

Winning conditions may vary depending on the game mode and may include achieving a highest simulated portfolio value, completing investment challenges, or performing favorably within a set period.

### Physical and Hybrid Game Formats

The system may be implemented in a physical format using cards, chips, tokens, and game boards in a physical board game format representing digital assets or gameplay mechanics.

A hybrid implementation may integrate physical components with digital interfaces, enabling combined gameplay wherein physical actions may be represented or tracked digitally.

### Educational Component

The system may include educational features such as tutorials or lessons relating to financial concepts or investment strategies.

### AI Integration

Artificial intelligence components may be included to provide automated strategic recommendations, analyze player actions, or adapt challenges.

### Community Features

The system may support a community-driven environment allowing players to share strategies, trading insights, or learn from each other.

Collaborative investment scenarios may allow players to share strategies or trading insights during gameplay.

### Augmented Reality (AR) and Virtual Reality (VR) Integration

AR or VR features may be used to present visualizations of asset behavior, portfolio status, or simulated market environments within a 3D environment. These features may provide immersive interaction with represented digital assets.

Overlay financial data may present updated information dynamically within the user interface.

In certain digital modes, the system presents a virtual trading environment in which dynamic financial data is displayed during gameplay.

### User Interaction Formats

The system may be implemented on web-based platforms, mobile applications, and desktop platforms. User interactions may involve real-time updates, asset tracking, and a portfolio management interface.

In some implementations, the platform supports multiplayer options.

In digital implementations, the system can provide real-time updates for asset tracking and portfolio management.

Players can execute simulated investment actions via touch or click interfaces.

### Physical Interaction

Players may interact with cards, tokens, game boards, or other physical components representing blockchain-based assets, adding tactile elements to gameplay.

### Hybrid Format

Hybrid formats facilitate physical component interactions with digital platforms, enabling various gameplay styles.

### Monitoring and Tracking

The interface may track player actions, asset histories, portfolio performance, and gameplay milestones. This information may be used to unlock rewards or additional gameplay modes.

In certain modes, player ranking may be presented via a leaderboard.

### Computer System Implementation

The system may be implemented using one or more computer systems consisting of processors, memory, input/output interfaces, and display devices.

Program modules may execute on a processor to carry out methods described herein, including value adjustments, rule processing, and portfolio tracking.
Program modules execute methods that apply the dynamic elements to representations (data structures) of blockchain-based assets to adjust values during gameplay.
In some implementations, the portfolio management interface includes program modules executed by one or more processors to apply the dynamic elements to stored representations (data structures) of the blockchain-based assets.”

Execution of program modules may leverage cloud computing technologies to provide access to a diverse range of blockchain-based assets.

### General Implementation Notes

Certain elements of the invention may be implemented in software, hardware, or a combination of both. Steps described in sequence may occur in parallel or in a different order. Variations consistent with the scope of the claims are possible.

### Conclusion

The embodiments described above are illustrative. Variations and equivalents falling within the scope of the appended claims are embraced by the invention.

1-122. (canceled)

I/We claim

123. A computer-implemented game system for simulating financial markets using blockchain-based assets, the system comprising:
a. stored data structures representing a set of asset classes selected from the group consisting of cryptocurrencies, digital tokens, altcoins, non-fungible tokens (NFTs), and memecoins;
b. dynamic elements selected from the group consisting of market trends, player decisions, seasonal factors, and external events comprising regulatory changes or economic shifts;
c. one or more processors executing program modules configured to apply the dynamic elements to the stored data structures to compute real-time simulated asset value adjustments during gameplay;
d. in a digital format, program modules configured to execute portfolio-management actions selected from the group consisting of buying, selling, holding, and swapping the asset classes based on the simulated asset values;
e. a portfolio management interface configured to display historical performance metrics and current simulated asset values, and to receive player inputs to manage the asset classes;
f. a reward system configured to provide blockchain-based rewards, points, credits, in-game advantages, or real-world rewards based on player milestones;
g. a gameplay format adaptable for digital, physical, or hybrid interaction, wherein physical game components are usable in combination with the digital format;

124. The system of claim 123, wherein the game environment further represents traditional financial instruments including stocks, commodities, or bonds.

125. The system of claim 123, wherein the dynamic elements comprise external events including regulatory changes or economic shifts.

126. The system of claim 123, wherein player decisions affect asset values and create a reactive environment.

127. The system of claim 123, wherein the rewards comprise blockchain-based assets redeemable within the game environment or for in-game advantages.

128. The system of claim 123, wherein the program modules are configured to adjust asset values of the blockchain-based assets during gameplay based on the dynamic elements, including market trends, player interactions, seasonal influences, and external events.

129. The system of claim 123, wherein the physical format includes a game board having physical components comprising cards or chips, representing blockchain assets and gameplay mechanics.

130. The system of claim 123, wherein blockchain-issued assets including tokens or NFTs are used as in-game elements representing blockchain-based assets.

131. The system of claim 123, further comprising multiplayer options with compatibility across platforms.

132. The system of claim 123, wherein the digital implementation optionally integrates blockchain services.

133. The system of claim 123, further comprising a leaderboard ranking players based on historical performance metrics.

134. The system of claim 123, wherein hybrid interactions integrate digital experiences with physical formats.

135. The system of claim 123, wherein augmented reality enables immersive gaming experiences through realistic simulations of market scenarios.

136. The system of claim 123, wherein virtual reality enables gameplay within a 3D environment.

137. The system of claim 123, further comprising artificial intelligence components configured to provide automated suggestions or strategic recommendations.

138. The system of claim 137, wherein the artificial intelligence adapts challenges to improve user engagement based on player behavior or market trends.

139. The system of claim 123, wherein the program modules are executed in a distributed computing environment comprising remote processing devices connected via a network, enabling access to blockchain-based asset data across multiple computing platforms.

140. The system of claim 123, wherein the program modules apply dynamic elements such as market trends, real-time data, player decisions, seasonal factors, regulatory changes, or economic shifts to the stored data structures to influence the value of the blockchain-based assets.

141. The system of claim 123, wherein augmented-reality (AR) features overlay financial data for players to view updated financial data dynamically.

142. The system of claim 123, wherein players complete investment challenges that affect winning conditions.

143. The system of claim 123, wherein players share strategies or trading insights within a collaborative investment scenario.

144. The system of claim 123, further comprising game modes that define various game objectives, including portfolio value and single asset holding, with leaderboard integration.

145. The system of claim 123, further comprising an educational component providing tutorials, market analysis or interactive lessons related to financial principles or investment strategies.

146. The system of claim 123, further comprising mechanisms that monitor player progress, portfolio performance or interaction history to unlock new features, challenges, rewards, and competitive dynamics.

147. The system of claim 123, wherein a winning condition is based on achieving highest portfolio value, completing investment challenges or maximizing returns over a set period.

148. The system of claim 123, wherein the game system is accessible through mobile, web-based platforms, desktop, physical, or hybrid formats.

149. The system of claim 123, wherein virtual-reality (VR) features present a 3D environment displaying financial data dynamically during gameplay.

150. The system of claim 123, wherein physical gameplay interactions are captured by the digital experience to update player portfolios in real time.

151. The system of claim 123, wherein players can interchange assets within the game by switching between different asset types to enhance strategic depth and gameplay.
